(19) United States
(12) Patent Application Publication
(10) Pub. No.: US 2021/0139134 A1
(43) Pub. Date: May 13, 2021

(54) HYDRAULIC CYLINDER WITH MATCHING BIAS

(71) Applicant: Bell Textron Inc., Fort Worth, TX (US)

(72) Inventors: Brady G. Atkins, Euless, TX (US); Robert Reynolds, Euless, TX (US)

(73) Assignee: Bell Textron Inc., Fort Worth, TX (US)

(21) Appl. No.: 16/679,172

(22) Filed: Nov. 9, 2019

(51) Int. Cl. B64C 13/16; F15B 20/00; F15B 11/16

(52) U.S. Cl. CPC B64C 13/16; F15B 11/16; F15B 20/008

(57) ABSTRACT

A hydraulic actuator has a lower cylinder comprising a lower cylinder extension area and a lower cylinder retraction area, an upper cylinder comprising an upper cylinder extension area and an upper cylinder retraction area, and an actuator shaft. The actuator shaft has a lower cylinder piston disposed in the lower cylinder, an upper cylinder piston disposed in the upper cylinder, a lower shaft connecting the lower cylinder piston to the upper cylinder piston, and an upper shaft extending from the upper cylinder piston and at least partially externally from the upper cylinder. At least one of fluid flow of the lower cylinder matches fluid flow of the upper cylinder and (1) an internal diameter of the lower cylinder is not equal to the an internal diameter of the upper cylinder and (2) a diameter of the lower shaft is not equal to a diameter of the upper shaft.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND

Aircraft include complex flight control systems having various flight control components that are electrical, mechanical, hydraulic, pneumatic, magnetic, and/or any combination thereof. These flight control components are capable of adjusting the flight characteristics of an aircraft to enable various operational modes of the aircraft, speeds and/or altitudes, and/or environmental conditions. Due to the forces imparted on many of these flight control components, some flight control components may be prone to failure, which may result in degraded control, loss of control, and/or total catastrophic loss of the aircraft if the failure modes of these components are not mitigated.

### BRIEF DESCRIPTION OF THE DRAWINGS

FIG. 1 is a side view of an aircraft according to this disclosure.

FIG. 2 is a side view of a hydraulic actuator system of the aircraft of FIG. 1.

FIG. 3 is a cross-sectional side view of a hydraulic actuator of the hydraulic actuator system of FIG. 2.

FIG. 4 is a cross-sectional side view of another embodiment of a hydraulic actuator.

FIG. 5 is a cross-sectional side view of an alternative embodiment of a hydraulic actuator.

FIG. 6 is a cross-sectional side view of another alternative embodiment of a hydraulic actuator.

FIG. 7 is a schematic diagram of a control system suitable for implementing embodiments of this disclosure.

FIG. 8 is a schematic diagram of the control input logic of the control system of FIG. 7.

FIG. 9 is a table of dimensions of an exemplary embodiment of each of the hydraulic cylinders of FIGS. 3-6.

FIG. 10 is a flowchart of a method of operating an aircraft according to this disclosure.

FIGS. 11A, 11B, 12A-12C, 13A, 13B, 14, 15A, and 15B are schematic representations of additional alternative embodiments of hydraulic cylinders according to the disclosure.

### DETAILED DESCRIPTION

In this disclosure, reference may be made to the spatial relationships between various components and to the spatial orientation of various aspects of components as the devices are depicted in the attached drawings. However, as will be recognized by those skilled in the art after a complete reading of this disclosure, the devices, members, apparatuses, etc. described herein may be positioned in any desired orientation. Thus, the use of terms such as “above,” “below,” “upper,” “lower,” or other like terms to describe a spatial relationship between various components or to describe the spatial orientation of aspects of such components should be understood to describe a relative relationship between the components or a spatial orientation of aspects of such components, respectively, as the device described herein may be oriented in any desired direction.

FIG. 1 is a side view of an aircraft 100 according to this disclosure. In the embodiment shown, aircraft 100 is a tiltrotor. However, in other embodiments, aircraft 100 may be any other type of aircraft. Aircraft 100 generally comprises a fuselage 102 and a wing assembly 104 comprising a plurality of wings 106 extending therefrom. A pylon 108 is pivotally coupled to each wing 106. Each pylon 108 comprises a rotor system 110 having a plurality of rotor blades 112 coupled thereto. Each pylon 108 is selectively pivotable between a horizontal orientation and a vertical orientation with respect to the fuselage 102 and associated wing 106 to adjust the thrust angle and transition the aircraft 100 between an airplane mode and a helicopter mode. Accordingly, the airplane mode is associated with a more horizontally-oriented thrust angle and propelling the aircraft 100 forward in flight, while the helicopter mode is associated with a more vertically-oriented thrust angle and propelling the aircraft 100 to and from a landing area. Furthermore, each pylon 108 comprises a hydraulic actuator system 200 for adjusting the pitch of the rotor blades 112 of each respective rotor system 110. A flight control system 120 may selectively control the hydraulic actuator systems 200.

FIG. 2 is a side view of a hydraulic actuator system 200 of aircraft 100. Hydraulic actuator system 200 may be controlled by flight control system 120 and comprises a lower hydraulic control valve 202, an upper hydraulic control valve 204, and a tandem hydraulic actuator 210 having a lower cylinder 212 and an upper cylinder 214 coaxially aligned with the lower cylinder 212. The lower cylinder 212 is hydraulically controlled by the lower hydraulic control valve 202, while the upper cylinder 214 is hydraulically controlled by the upper hydraulic control valve 204. The lower hydraulic control valve 202 and the upper hydraulic control valve 204 may be direct drive valves, electro-hydraulic servo valves, or any other hydraulic control valve. Additionally, lower hydraulic control valve 202 and upper hydraulic control valve 204 can alternatively be 3-way or 4-way control valves and can be used in one or more of the embodiments disclosed herein. Accordingly, operation of the lower hydraulic control valve 202 and the upper hydraulic control valve 204 causes selective hydraulic extension and/or retraction of the hydraulic actuator 210 to control the pitch of the rotor blades 112 of the aircraft 100 through articulation of a swashplate assembly 206 that is commonly known in the art. While only one hydraulic actuator system 200 is shown, it will be appreciated that each pylon 108 may comprise additional hydraulic actuator systems 200. Further, in some embodiments, the hydraulic actuator 210 may be coupled to a portion of the pylon 108.

FIG. 3 is a cross-sectional side view of the hydraulic actuator 210 of the hydraulic actuator system 200 of FIG. 2. Hydraulic actuator 210 comprises lower cylinder 212 having an outer body 213, upper cylinder 214 also having an outer body 215, and an actuator shaft 216. The actuator shaft 216 comprises a coaxially aligned lower cylinder piston 218, lower shaft 220, upper cylinder piston 222, and upper shaft 224. Actuator shaft 216 also comprises an aperture 226 disposed through the lower cylinder piston 218 and at least partially through the lower shaft 220 and is configured to receive a position sensor 228 (e.g., a linear variable differential transformer sensor) to detect the position of the actuator shaft 216 during operation. Although a linear variable differential transformer sensor is specifically noted as a possible type of position sensor 228, any other suitable linear position sensing device can alternatively be utilized. Since the position sensor 228 is exposed to fluid in the lower volume 230, the position sensor 228 is considered a “wet-tube” sensor. The lower cylinder piston 218 separates the lower cylinder 212 into a lower volume 230 and an upper volume 232. The upper cylinder piston 222 separates the upper cylinder 214 into a lower volume 234 and an upper volume 236. The lower shaft 220 extends from the lower cylinder piston 218 at least partially into the upper cylinder 214 to the upper cylinder piston 222. The upper shaft 224 extends from the upper cylinder piston 222 and at least partially externally from the upper cylinder 214.

Rings or seals 238 are disposed between portions of the actuator shaft 216 and the cylinders 212, 214 to prevent fluid leakage between cylinders 212, 214, between upper and lower volumes, and between the upper cylinder 214 and the external environment. A fitting 240 is disposed on the end of the upper shaft 224 for connection to the swashplate assembly 206. Each volume 230, 232, 234, 236 of the cylinders 212, 214 comprises a respective port 242, 244, 246, 248 for connecting to the hydraulic control valves 202, 204 to allow for selective changing of the fluid present in volumes 230, 232, 234, 236 to extend and retract the actuator shaft 216 with respect to the cylinders 212, 214. In the embodiment shown, lower cylinder 218 has diameter “d_{C1},” lower shaft 220 has diameter “d_{R1},” upper cylinder 222 has diameter “d_{C2},” and upper shaft 224 has diameter “d_{R2}.” It will be appreciated that references to cylinder diameters are referring to internal diameters while references to shaft and/or balance tube diameters are referring to external diameters. Accordingly, lower volume 230 of lower cylinder 212 has an extension area “A_{L1},” upper volume 232 of lower cylinder 212 has a retraction area “A_{U1},” lower volume 234 of upper cylinder 214 has an extension area “A_{L2},” and upper volume 236 of upper cylinder 214 has a retraction area “A_{U2}.” The extension areas are associated with the area on which fluid can act to extend the actuator shaft 216 and retraction areas are associated with the area on which fluid can act to retract the actuator shaft 216.

Most generally, the geometric relationships of the components of hydraulic actuator 210 are represented by Equations 1-11 below, with A_{U1}, A_{U2}, and d_{R2} being known values and with the assumptions that A_{U1}=A_{U2} and A_{L1}=A_{L2}. Also, in this embodiment, d_{C2} is greater than d_{C1}.

$$\begin{matrix}{A}_{L 1} = \frac{π}{4} {d}_{C 1}^{2} & Equation 1 \\ {A}_{U 1} = \frac{π}{4} ( {d}_{C 1}^{2} - {d}_{R 1}^{2} ) & Equation 2 \\ {A}_{L 2} = \frac{π}{4} ( {d}_{C 2}^{2} - {d}_{R 1}^{2} ) & Equation 3 \\ {A}_{U 2} = \frac{π}{4} ( {d}_{C 2}^{2} - {d}_{R 2}^{2} ) & Equation 4 \\ {d}_{C 2}^{2} = \frac{4 {A}_{U 2}}{π} + {d}_{R 2}^{2} & Equation 5 \\ \frac{π}{4} {d}_{C 1}^{2} = \frac{π}{4} ( {d}_{C 2}^{2} - {d}_{R 1}^{2} ) & Equation 6 \\ {d}_{C 1}^{2} = {d}_{C 2}^{2} - {d}_{R 1}^{2} & Equation 7 \\ \frac{π}{4} ( {d}_{C 1}^{2} - {d}_{R 1}^{2} ) = \frac{π}{4} ( {d}_{C 2}^{2} - {d}_{R 2}^{2} ) & Equation 8 \\ {d}_{C 1}^{2} = {d}_{C 2}^{2} - {d}_{R 2}^{2} + {d}_{R 1}^{2} & Equation 9 \\ {d}_{C 1}^{2} = {d}_{C 2}^{2} - {d}_{R 2}^{2} = {d}_{C 2}^{2} - {d}_{R 2}^{2} + {d}_{R 1}^{2} & Equation 10 \\ 2 {d}_{R 1}^{2} = {d}_{R 2}^{2} & Equation 11 \\ AL 1 E = AL 1 - AU 1 & Equation 12 \\ AL 2 E = AL 2 - AU 2 & Equation 13\end{matrix}$$

By matching A_{L1} to A_{L2}, the lower cylinder 212 and upper cylinder 214 are geometrically optimized to have substantially the same force bias, pressure, and flow during operation. This provides increased consistency for control, provides better fluid management, and can allow for failure mode management of hardover extension failures. A hardover extension failure occurs when a hydraulic control valve 202, 204 fails, such that the hydraulic actuator 210 is commanded by the failed hydraulic control valve 202, 204 to extend regardless of the command signal from the flight control system 120. During a hardover extension failure in a traditional dual actuator system, the healthy actuator must overcome not only the extension force of the commanded cylinder associated with the hardover extension failure, but also must overcome the tensile forces generated by the rotor system or flight control 110 in the same direction, thereby requiring an extremely high force to be applied by the healthy cylinder. In alternative embodiments hydraulic actuators substantially similar to hydraulic actuators 210, 310 can utilize 4-way valves to bias toward an extended position as opposed to a retracted position.

When regenerative 3-way valving is utilized such that AU1 and AU2 are always connected to system pressure and motion control in both directions is accomplished by varying the pressure on AL1 and AL2, the tandem hydraulic actuator 210 reduces the amount of force generated by the failed cylinder thereby reducing the pressure differential that must be generated in the healthy cylinder to mitigate the hardover extension failure. The effective area of the lower cylinder areas can be defined as AL1E=AL1−AU1 and AL2E=AL2−AU2. This is accomplished by the extend area of AL1 and AL2 being only marginally greater than AU1 and AU2 in order to bias the actuator to retract in applications where the predominant loads are tensile. Further, this is accomplished by the lower cylinder 212 being controlled by the lower hydraulic control valve 202, and the upper cylinder 214 being independently controlled by the upper hydraulic control valve 214. This configuration provides independent control of the lower cylinder 212 and upper cylinder 214, in addition to redundancy with independent hydraulic control valves 202, 204. Thus, when one of the hydraulic control valves 202, 204 fails, the healthy hydraulic control valve 202, 204 can be operated to retract the actuator shaft 216 and overcome the hardover extension failure. When used in hydraulic actuator system 200, lower cylinder 212 and upper cylinder 214 are regenerative cylinders that allow use of mechanically synchronized, three-way hydraulic control valves 202, 204. By using matched “off-the-shelf” or commonly used hydraulic control valves 202, 204, cost savings can be substantial. Additionally, the configuration of actuator 210 using regenerative 3-way valving also provides the lowest weight cylinder configuration, thereby reducing the overall weight and power requirements of aircraft 100.

FIG. 4 is a cross-sectional side view of another embodiment of a hydraulic actuator 310. Hydraulic actuator 310 is substantially similar to hydraulic actuator 210 and is configured for use in hydraulic actuator system 200. However, as opposed to the “wet-tube” position sensor 228, hydraulic actuator 310 comprises a balance tube 320 (having a diameter “d_{BR}”) that isolates the position sensor 228 from the fluid in the lower volume 230 of the lower cylinder 212. Thus, when used with balance tube 320, position sensor 228 may be referred to as a “dry-tube” sensor. Additional seals 238 may also be used between the actuator shaft 216 and the balance tube 320.

Most generally, the geometric relationships of the components of hydraulic actuator 310 are represented by Equations 12-22 below, with A_{U1}, A_{U2}, d_{R2}, and d_{BR} being known values and with the assumptions that A_{U1}=A_{U2} and A_{L1}=A_{L2}. Also, in this embodiment, d_{C2} is greater than do.

$$\begin{matrix}{A}_{L 1} = \frac{π}{4} ( {d}_{C 1}^{2} - {d}_{BR}^{2} ) & Equation 14 \\ {A}_{U 1} = \frac{π}{4} ( {d}_{C 1}^{2} - {d}_{R 1}^{2} ) & Equation 15 \\ {A}_{L 2} = \frac{π}{4} ( {d}_{C 2}^{2} - {d}_{R 1}^{2} ) & Equation 16 \\ {A}_{U 2} = \frac{π}{4} ( {d}_{C 2}^{2} - {d}_{R 2}^{2} ) & Equation 17 \\ {d}_{C 2}^{2} = \frac{4 {A}_{U 2}}{π} + {d}_{R 2}^{2} & Equation 18 \\ \frac{π}{4} ( {d}_{C 1}^{2} - {d}_{Br}^{2} ) = \frac{π}{4} ( {d}_{C 2}^{2} - {d}_{R 1}^{2} ) & Equation 19 \\ {d}_{C 1}^{2} = {d}_{C 2}^{2} - {d}_{R 2}^{2} + {d}_{BR}^{2} & Equation 20 \\ \frac{π}{4} ( {d}_{C 1}^{2} - {d}_{R 1}^{2} ) = \frac{π}{4} ( {d}_{C 2}^{2} - {d}_{R 2}^{2} ) & Equation 21 \\ {d}_{C 1}^{2} = {d}_{C 2}^{2} - {d}_{R 2}^{2} + {d}_{R 1}^{2} & Equation 22 \\ {d}_{C 1}^{2} = {d}_{C 2}^{2} - {d}_{R 2}^{2} + {d}_{BR}^{2} = {d}_{C 2}^{2} - {d}_{R 2}^{2} + {d}_{R 1}^{2} & Equation 23 \\ 2 {d}_{R 1}^{2} = {d}_{BR}^{2} + {d}_{R 2}^{2} & Equation 24 \\ AL 1 E = AL 1 - AU 1 & Equation 25 \\ AL 2 E = AL 2 - AU 2 & Equation 26\end{matrix}$$

FIG. 5 is a cross-sectional side view of an alternative embodiment of a hydraulic actuator 410. Hydraulic actuator 410 comprises a lower cylinder 412 having an outer body 413, upper cylinder 414 also having an outer body 415, and an actuator shaft 416. The actuator shaft 416 comprises a lower cylinder piston 418, a lower shaft 420, an upper cylinder piston 422, and an upper shaft 424. Actuator shaft 416 also comprises an aperture 426 disposed through the lower cylinder piston 418 and at least partially through the lower shaft 420 and is configured to receive a position sensor 428 (e.g., a linear variable differential transformer sensor) to detect the position of the actuator shaft 416 during operation. Since the position sensor 428 is exposed to fluid in the lower volume 430, the position sensor 428 is considered a “wet-tube” sensor. The lower cylinder piston 418 separates the lower cylinder 412 into a lower volume 430 and an upper volume 432. The upper cylinder piston 422 separates the upper cylinder 414 into a lower volume 434 and an upper volume 436. The lower shaft 420 extends from the lower cylinder piston 418 at least partially into the upper cylinder 414 to the upper cylinder piston 422. The upper shaft 424 extends from the upper cylinder piston 422 and at least partially externally from the upper cylinder 414.

Rings or seals 238 are disposed between portions of the actuator shaft 416 and the cylinders 412, 414 to prevent fluid leakage between cylinders 412, 414, between upper and lower volumes, and between the upper cylinder 414 and the external environment. A fitting 440 is disposed on the end of the upper shaft 424 for connection to the swashplate assembly 206. Each volume 430, 432, 434, 436 of the cylinders 412, 414 comprises a respective port 442, 444, 446, 448 for connecting to the hydraulic control valves 202, 204 to allow for selective movement of fluid within the volumes 430, 432, 434, 436 to extend and retract the actuator shaft 416 with respect to the cylinders 412, 414. In the embodiment shown, lower cylinder 412 has diameter “d_{C1},” lower shaft 420 has diameter “d_{R1},” upper cylinder 414 has diameter “d_{C2},” and upper shaft 424 has diameter “d_{R2}.” Accordingly, lower volume 430 of lower cylinder 412 has an extension area “A_{L1},” upper volume 432 of lower cylinder 412 has a retraction area “A_{U1},” lower volume 434 of upper cylinder 414 has an extension area “A_{L2},” and upper volume 436 of upper cylinder 414 has a retraction area “A_{U2}.”

Hydraulic actuator 410 is generally substantially similar to hydraulic actuator 210 and configured for use in hydraulic actuator system 200. However, in hydraulic actuator 410, d_{C1} is larger than d_{C2}. Lower cylinder 412 is a regenerative cylinder and utilizes 3-way hydraulic control valve 202 that modulates pressure in A_{L1} while maintaining system pressure in A_{U1}. Upper cylinder 414 is non-regenerative and is controlled by valve 204 which is a 4-way hydraulic control valve so that pressure and flow on both sides of the piston are dynamically controlled. An equivalent lower volume extension area of lower cylinder 412 (A_{L1E}) (calculated as A_{L1E}=A_{L1}−A_{U1}) is equal to A_{L2}. By matching A_{L1E} to A_{L2}, the lower cylinder 412 and upper cylinder 414 are geometrically optimized to have substantially the same force bias, pressure, and flow during operation. This provides increased consistency for control, provides better fluid management, and allows for failure mode management of hardover extension failures. The tandem hydraulic actuator 410 reduces the amount of force generated by a failed cylinder, thereby reducing the pressure differential that must be generated in the healthy cylinder to mitigate the hardover extension failure. This is accomplished in the lower cylinder by the extend area of AL1 being only marginally greater than AU1 and in the upper cylinder by the extend area of AL2 being less than the retract area AU2. Both the upper and lower cylinders of the actuator are configured to bias the actuator to retract in applications where the predominant loads are tensile.

Further, mitigation of hardover extension failure is accomplished by the lower cylinder 412 being controlled by the lower hydraulic control valve 202, and the upper cylinder 414 being independently controlled by the upper hydraulic control valve 214. This configuration provides independent control of the lower cylinder 412 and upper cylinder 414, in addition to redundancy with independent hydraulic control valves 202, 204. Thus, when one of the hydraulic control valves 202, 204 fails, the healthy hydraulic control valve 202, 204 can be operated to retract the actuator shaft 416 and overcome the hardover extension failure. As such, hydraulic actuator 410 provides hardover extension failure mitigation in a substantially similar manner as hydraulic actuators 210, 310 by overcoming the extension force of the commanded cylinder associated with the hardover extension failure and the tensile forces acting on the rotor system 110.

Most generally, the geometric relationships of hydraulic actuator 410 are represented by Equations 23-34 below, with A_{U1}, A_{U2}, and d_{R2} being known values and with the assumptions that A_{U1}=A_{U2} and A_{L1E}=A_{L2}. Also, d_{C1} is greater than d_{C2}.

$$\begin{matrix}{A}_{L 1} = \frac{π}{4} {d}_{C 1}^{2} & Equation 27 \\ {A}_{U 1} = \frac{π}{4} ( {d}_{C 1}^{2} - {d}_{R 1}^{2} ) & Equation 28 \\ {A}_{L 1 E} = {A}_{L 1} - {A}_{U 1} & Equation 29 \\ {A}_{L 1 E} = \frac{π}{4} {d}_{C 1}^{2} - \frac{π}{4} ( {d}_{C 1}^{2} - {d}_{R 1}^{2} ) & Equation 30 \\ {A}_{L 1 E} = \frac{π}{4} ( {d}_{R 1}^{2} ) & Equation 31 \\ {A}_{L 2} = \frac{π}{4} ( {d}_{C 2}^{2} - {d}_{R 1}^{2} ) & Equation 32 \\ {A}_{U 2} = \frac{π}{4} ( {d}_{C 2}^{2} - {d}_{R 2}^{2} ) & Equation 33 \\ {d}_{C 2}^{2} = \frac{4 {A}_{U 2}}{π} + {d}_{R 2}^{2} & Equation 34 \\ \frac{π}{4} ( {d}_{R 1}^{2} ) = \frac{π}{4} ( {d}_{C 2}^{2} - {d}_{R 1}^{2} ) & Equation 35 \\ 2 {d}_{R 1}^{2} = {d}_{C 2}^{2} & Equation 36 \\ \frac{π}{4} ( {d}_{C 2}^{2} - {d}_{R 1}^{2} ) = \frac{π}{4} ( {d}_{C 2}^{2} - {d}_{R 2}^{2} ) & Equation 37 \\ {d}_{C 1}^{2} = {d}_{C 2}^{2} - {d}_{R 2}^{2} + {d}_{R 1}^{2} = 3 {d}_{R 1}^{2} - {d}_{R 2}^{2} & Equation 38\end{matrix}$$

FIG. 6 is a cross-sectional side view of another alternative embodiment of a hydraulic actuator 510. Hydraulic actuator 510 is substantially similar to hydraulic actuator 410 and configured for use in hydraulic actuator system 200. However, as opposed to the “wet-tube” position sensor 428, hydraulic actuator 510 comprises a balance tube 520 (diameter “D_{BR}”) that isolates the position sensor 428 from the fluid in the lower volume 430 of the lower cylinder 412. Thus, when used with balance tube 520, position sensor 428 may be referred to as a “dry-tube” sensor. Additional seals 438 may also be used between the actuator shaft 416 and the balance tube 520. Because of the space occupied by the balance tube 520, the hydraulic actuator 510 comprises lower total extension area (A_{L1}+A_{L2}) as compared to hydraulic actuator 410, while the total retraction area (A_{U1}+A_{U2}) remains substantially the same. However, hydraulic actuator 510 is also the largest configuration as compared to hydraulic actuators 210, 310, 410.

Most generally, the geometric relationships of the components of hydraulic actuator 510 are represented by Equations 35-23 below, with A_{U1}, A_{U2}, d_{R2}, and d_{BR} being known values and with the assumptions that A_{U1}=A_{U2} and A_{L1E}=A_{L2}. Also, d_{C1} is greater than d_{C2}.

$$\begin{matrix}{A}_{L 1} = \frac{π}{4} ( {d}_{C 1}^{2} - {d}_{BR}^{2} ) & Equation 39 \\ {A}_{U 1} = \frac{π}{4} ( {d}_{C 1}^{2} - {d}_{R 1}^{2} ) & Equation 40 \\ {A}_{L 2} = \frac{π}{4} ( {d}_{C 2}^{2} - {d}_{R 1}^{2} ) & Equation 41 \\ {A}_{U 2} = \frac{π}{4} ( {d}_{C 2}^{2} - {d}_{R 2}^{2} ) & Equation 42 \\ {d}_{C 2}^{2} = \frac{4 {A}_{U 2}}{π} + {d}_{R 2}^{2} & Equation 43 \\ {A}_{L 1 E} = {A}_{L 1} - {A}_{U 1} & Equation 44 \\ {A}_{L 1 E} = \frac{π}{4} ( {d}_{C 1}^{2} - {d}_{BR}^{2} ) - \frac{π}{4} ( {d}_{C 1}^{2} - {d}_{R 1}^{2} ) & Equation 45 \\ {A}_{L 1 E} = \frac{π}{4} ( {d}_{R 1}^{2} - {d}_{BR}^{2} ) & Equation 46 \\ \frac{π}{4} ( {d}_{R 1}^{2} - {d}_{BR}^{2} ) = \frac{π}{4} ( {d}_{C 2}^{2} - {d}_{R 1}^{2} ) & Equation 47 \\ 2 {d}_{R 1}^{2} = {d}_{C 2}^{2} + {d}_{BR}^{2} & Equation 48 \\ \frac{π}{4} ( {d}_{C 1}^{2} - {d}_{R 1}^{2} ) = \frac{π}{4} ( {d}_{C 2}^{2} - {d}_{R 2}^{2} ) & Equation 49 \\ {d}_{C 1}^{2} = {d}_{C 2}^{2} - {d}_{R 2}^{2} + {d}_{R 1}^{2} = {d}_{R 1}^{2} - {d}_{R 2}^{2} - {d}_{BR}^{2} & Equation 50\end{matrix}$$

FIG. 7 is a schematic diagram of a control system 600 suitable for implementing embodiments of this disclosure in aircraft 100. Control system 600 comprises a flight control system 120 suitable for controlling aircraft 100. Flight control system 120 comprises a first flight control computer (FCC1) 602, a second flight control computer (FCC2) 604, and a hydraulic actuator system 200 comprising a lower hydraulic control valve (HV1) 202 coupled to the first flight control computer (FCC1) 602, an upper hydraulic control valve (HV2) 204 coupled to the second flight control computer (FCC2) 604, and a hydraulic actuator 210, 310, 410, 510. In some embodiments, a crossover datalink can be provided to allow information sharing between FCC1 602 and FCC2 604. FCC1 602 controls HV1 202, which selectively moves fluid in lower cylinders 212, 412. First position sensor (PS1) 228, 428 provides feedback regarding the position of the hydraulic actuator 210, 310, 410, 510 to FCC1 602, while second position sensor (PS2) 228, 428 provides feedback regarding the position of the hydraulic actuator 210, 310, 410, 510 to FCC2 604. Feedback regarding the position of HV1 202 may also be received by FCC1 602, while feedback regarding the position of HV2 204 may be received by FCC2 604. Further, feedback from PS1 228, 428 and HV1 202 may be constantly or regularly provided to FCC1 602, while feedback from PS2 228, 428 and HV2 204 may be constantly or regularly provided to FCC2 604.

FIG. 8 is a schematic diagram of control input logic 700 of the control system 600 of FIG. 7. FCC1 602 and FCC2 604 each utilize control input logic 700. Utilizing control input logic 700, each of FCC1 602 and FCC2 604 receive actuator position feedback, which is compared to an actuator position command. This data may be passed through a first series of gains and/or filters and utilized to detect a hardover extension failure. FCC1 602 and FCC2 604 also receive HV1 202 and HV2 204 position feedback. This data may also be passed through a series of gains and/or filters and utilized to detect a hardover extension failure. When a hardover extension failure is detected, electrical control output to the healthy hydraulic control valve (HV1 202 or HV2 204) may retract the hydraulic actuator 210, 310, 410, 510 in accordance with methods disclosed herein to mitigate the hardover extension failure by overcoming the extension force of the commanded cylinder associated with the hardover extension failure and the tensile forces acting on the rotor system 110.

FIG. 9 is a table of dimensions of some embodiments of each of the hydraulic actuators 210, 310, 410, 510 of FIGS. 3-6. It will be appreciated that in each embodiment disclosed herein, the A_{U1}, A_{U2}, D_{R2}, and D_{BR} (diameter of balance tube 320, 520, where applicable) are known. A_{U1} and A_{U2} will be sized by the output force requirement, D_{R2} is a function of the stroke of the actuator shaft 216, 416, as well as the buckling and handling loads, and D_{BR} is set by the diameter of the position sensors 228, 428.

FIG. 10 is a flowchart of a method 800 of operating an aircraft 100 according to this disclosure. Method 800 begins at block 802 by providing an aircraft 100 comprising a control system 600 having a first flight control computer (FCC1) 602, a second flight control computer (FCC2) 604, and a hydraulic actuator system 200 comprising a lower hydraulic control valve (HV1) 202 coupled to the first flight control computer (FCC1) 602, an upper hydraulic control valve (HV2) 204 coupled to the second flight control computer (FCC2) 604, and a tandem hydraulic actuator 210, 310, 410, 510. Method 800 continues at block 804 by detecting a hardover extension failure in a hydraulic actuator 210, 310, 410, 510. This may be accomplished by FCC1 602 and/or FCC2 604 when the commanded position of the hydraulic actuator 210, 310, 410, 510 does not match the actual actuator position as measured by PS1 228, 428 and PS2 228, 428. Alternatively, a hardover extension failure may be detected by FCC1 602 when the commanded position of HV1 202 does not match the actual position of HV1 202, and by FCC2 when the commanded position of HV2 204 does not match the actual position of HV2 204. Method 800 continues at block 806 by providing an electrical control output to the healthy hydraulic control valve (HV1 202 or HV2 204) to retract the hydraulic actuator 210, 310, 410, 510 to mitigate the hardover extension failure. Mitigation of the hardover extension failure requires overcoming the extension force in the commanded cylinder in the hydraulic actuator 210, 310, 410, 510 provided by the faulty hydraulic control valve (HV1 202 or HV2 204) associated with the hardover extension failure and the tensile forces acting on the rotor system 110 of the aircraft 100.

Referring now to FIGS. 11A and 11B, two embodiments of hydraulic actuators with tandem hydraulic cylinders designed with matched upper and lower cylinders are shown. Actuator 900 of FIG. 11A is biased to extend while actuator 1000 is biased to retract. Both actuators 900, 1000 use 4-way valving. In both actuators 900, 1000, AL1=AL2 and AU1=AU2.

Referring now to FIGS. 12A, 12B, and 12C, three embodiments of hydraulic actuators with tandem hydraulic cylinders and unequal lower areas for reduced envelope are provided. The upper and lower cylinders are matched by using geometry and valving. The hydraulic actuator 1100 of FIG. 12A can be biased to extend using a 4-way valve for each of the cylinders and when both AL1=AL2 and AU1=AU2. The hydraulic actuator 1100 can be biased to retract using a 3-way valve for each of the cylinders and when both AL1E=AL2E and AU1=AU2. The actuator 1100 has no internal position monitor. The hydraulic actuator 1200 of FIG. 12B comprises a wet install position sensor and can be biased to extend using a 4-way valve for each of the cylinders and when both AL1=AL2 and AU1=AU2. The hydraulic actuator 1300 of FIG. 12C comprises a dry install position sensor with a balance tube and can be biased to retract using a 3-way valve for each of the cylinders and when both AL1E=AL2E and AU1=AU2.

Referring now to FIGS. 13A and 13B, two embodiments of hydraulic actuators with alternate directional bias, primarily for retraction bias, are shown. The hydraulic actuator 1400 of FIG. 13A comprises matched tandem cylinders with larger lower cylinder diameter and a wet position sensor. The actuator 1400 is biased to retract when 3-way valving is used with cylinder 1, 4-way valving is used with cylinder 2, and when both AL1E=AL2E and AU1=AU2. The hydraulic actuator 1500 of FIG. 13B comprises matched tandem cylinders with larger lower cylinder diameter and a dry position sensor with a balance tube. The actuator 1500 is biased to retract when 3-way valving is used with cylinder 1, 4-way valving is used with cylinder 2, and when both AL1E=AL2E and AU1=AU2.

Referring now to FIG. 14, an embodiment of a hydraulic actuator 1600 comprising a tandem moving body (as system output) with matched cylinders, directional bias, and dual ground connections is shown. As shown, the actuator 1600 is biased toward the right, however, by flipping the direction of installation, the actuator 1600 can be biased toward the left. For this embodiment to work, both cylinders are associated with 4-way valves, AL1=AL2, and AU1=AU2.

Referring now to FIGS. 15A and 15B, two embodiments of hydraulic actuators having dual tandem cylinders, a moving body, and single ground connection are shown. The actuator 1700 of FIG. 15A is biased to retract when 4-way valving is associated with cylinder 1, 3-way valving is associated with cylinder 2, and both AL1=AL2 and AU1=AU2. The actuator 1800 of FIG. 15B is biased to extend when 4-way valving is associated with cylinder 1, 3-way valving is associated with cylinder 2, and both AL1=AL2 and AU1=AU2. The hydraulic actuator embodiments of this disclosure generally have matched fluid flow through the two cylinders and matched force from the two cylinders (or matched pressure differential between cylinders of the actuators). The embodiments generally have either unequal internal cylinder diameters or unequal rod diameters. Not counting for non-ideal manufacturing tolerances in valving or cylinder construction, all embodiments provide matched nominal flow, matched nominal force, and matched nominal pressure differentials. Embodiments with both cylinders having 4-way or 3-way valves additionally match the nominal absolute pressures between the cylinders. Embodiments with two 3-way or 4-way valves have matching nominal cylinder pressure and pressure differentials. Embodiments with mixed 3-way and 4-way valves have matching nominal pressure differentials, where the term nominal implies that the values will be within tolerances allowing for differences in manufacturing and signal processing, electronics, etc.

In some embodiments, information regarding failed hydraulic valves can be obtained by measuring a spool position in each hydraulic valve with a LVDT which can isolate a failed hydraulic valve when a command from a flight control computer is compared to feedback from the LVDT. In other embodiments, delta pressure sensors can be used on each cylinder (to measure the pressure across the piston head) to identify a failed hydraulic valve while actuator position sensors can be used for position control (as opposed to failure detection). In some embodiments, two or more flight control computers can be used to control two or more control valves. In some embodiments, systems use a main control valve (MCV), where the hydraulic valves (HVs) (2 or more) control the motion of the MCV. The MCV may have two or more cylinders, each associated with an EV that is controlling the cylinder in a manner substantially similar to the manner in which other cylinders herein have been described as being controlled, and although not necessarily matched, in some embodiments the cylinders may be matched. The pistons associated with each cylinder in the MCV are mechanically linked together and, in-turn, are mechanically linked to two or more control valves also within the MCV. These control valves may, in-turn, control cylinders within an actuator. The control valves within the MCV and the actuators being controlled may be arranged in ways substantially similar to the arrangements of control valves and actuator cylinders being described and claimed herein. Although the systems and methods disclosed primarily reference addressing extension failures related to systems that primarily involve tensile loads, in alternative embodiments, substantially similar systems and methods can be provided to identify, isolate, and passivate retraction failures instead.

While some embodiments are described herein as comprising two cylinders, such as an upper hydraulic cylinder and a lower hydraulic cylinder, in alternative embodiments, a system can comprise three or more cylinders with cylinder and/or related rod diameters being sized in a graduated or trending manner so that a third or intermediate cylinder and/or a third or an intermediate rod diameter is sized between the sizes of at least two other cylinders and/or rods.

At least one embodiment is disclosed, and variations, combinations, and/or modifications of the embodiment(s) and/or features of the embodiment(s) made by a person having ordinary skill in the art are within the scope of this disclosure. Alternative embodiments that result from combining, integrating, and/or omitting features of the embodiment(s) are also within the scope of this disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, Rₗ, and an upper limit, Rᵤ, is disclosed, any number falling within the range is specifically disclosed. In particular, the following numbers within the range are specifically disclosed: R=Rₗ+k*(Rᵤ−Rₗ), wherein k is a variable ranging from 1 percent to 100 percent with a 1 percent increment, i.e., k is 1 percent, 2 percent, 3 percent, 4 percent, 5 percent, . . . 50 percent, 51 percent, 52 percent, . . . , 95 percent, 96 percent, 95 percent, 98 percent, 99 percent, or 100 percent. Moreover, any numerical range defined by two R numbers as defined in the above is also specifically disclosed.

Use of the term “optionally” with respect to any element of a claim means that the element is required, or alternatively, the element is not required, both alternatives being within the scope of the claim. Use of broader terms such as comprises, includes, and having should be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present invention. Also, the phrases “at least one of A, B, and C” and “A and/or B and/or C” should each be interpreted to include only A, only B, only C, or any combination of A, B, and C.

What is claimed is:

1. A hydraulic actuator, comprising:
a lower cylinder comprising a lower cylinder extension area and a lower cylinder retraction area;
an upper cylinder comprising an upper cylinder extension area and an upper cylinder retraction area; and
an actuator shaft, comprising:
a lower cylinder piston disposed in the lower cylinder;
an upper cylinder piston disposed in the upper cylinder;
a lower shaft connecting the lower cylinder piston to the upper cylinder piston; and
an upper shaft extending from the upper cylinder piston and at least partially externally from the upper cylinder;
wherein fluid flow of the lower cylinder matches fluid flow of the upper cylinder and at least one of (1) an internal diameter of the lower cylinder is not equal to the an internal diameter of the upper cylinder and (2) a diameter of the lower shaft is not equal to a diameter of the upper shaft.

2. The hydraulic actuator of claim 1, wherein a diameter of upper cylinder is larger than the diameter of the lower cylinder.

3. The hydraulic actuator of claim 2, wherein the lower cylinder extension area is equal to the upper cylinder extension area.

4. The hydraulic actuator of claim 3, wherein the lower cylinder is controlled by a 3-way hydraulic control valve, and the upper cylinder is independently controlled by a matching 3-way hydraulic control valve.

5. The hydraulic actuator of claim 1, wherein a diameter of upper cylinder is smaller than a diameter of the lower cylinder.

6. The hydraulic actuator of claim 5, wherein a difference between the lower cylinder extension area and the lower cylinder retraction area is equal to the upper cylinder extension area.

7. The hydraulic actuator of claim 6, wherein the lower cylinder is controlled by a 3-way hydraulic control valve, and the upper cylinder is independently controlled by a 4-way hydraulic control valve.

8. The hydraulic actuator of claim 1, wherein the actuator shaft comprises an aperture disposed through the lower cylinder piston and at least partially through the lower shaft to receive a position sensor.

9. The hydraulic actuator of claim 8, wherein the hydraulic actuator comprises a balance tube that isolates the position sensor from fluid in the lower cylinder.

10. An aircraft, comprising:
a hydraulic control system, comprising:
a lower hydraulic control valve;
an upper hydraulic control valve; and
a hydraulic actuator, comprising:
a lower cylinder comprising a lower cylinder extension area and a lower cylinder retraction area, the lower cylinder being controlled by the lower hydraulic control valve;
an upper cylinder comprising an upper cylinder extension area and an upper cylinder retraction area, the upper cylinder being controlled by the upper hydraulic control valve; and
an actuator shaft, comprising:
a lower cylinder piston disposed in the lower cylinder;
an upper cylinder piston disposed in the upper cylinder;
a lower shaft connecting the lower cylinder piston to the upper cylinder piston; and
an upper shaft extending from the upper cylinder piston and at least partially externally from the upper cylinder;
wherein fluid flow of the lower cylinder matches fluid flow of the upper cylinder and at least one of (1) an internal diameter of the lower cylinder is not equal to the an internal diameter of the upper cylinder and (2) a diameter of the lower shaft is not equal to a diameter of the upper shaft.

11. The aircraft of claim 10, wherein at least one of (1) the lower cylinder extension area is equal to the upper cylinder extension area and (2) a difference between the lower cylinder extension area and the lower cylinder retraction area is equal to the upper cylinder extension area.

12. The aircraft of claim 10, wherein at least one of: (1) the lower hydraulic control valve is controlled by a first flight control computer, and the upper hydraulic control valve is controlled by a second flight control computer, (2) the lower hydraulic cylinder is controlled by a first set of two flight control computers and the upper hydraulic cylinder is controlled by a second set of two flight control computers, (3) the lower hydraulic cylinder is controlled by a first flight control computer and the upper hydraulic cylinder is controlled by a set of two flight control computers that does not include the first flight control computer, (4) the upper hydraulic cylinder is controlled by a first flight control computer and the lower hydraulic cylinder is controlled by a set of two flight control computers that does not include the first flight control computer, and (5) any number of flight control computers act on a main control valve that comprises two mechanically linked control valves that control both the lower hydraulic cylinder, the upper hydraulic cylinder, and any cylinders in addition to the lower hydraulic cylinder and the upper hydraulic cylinder.

13. The aircraft of claim 12, wherein feedback regarding the position of the lower hydraulic control valve is provided to the first flight control computer, and wherein feedback regarding the position of the upper hydraulic control valve is provided to the second flight control computer.

14. The aircraft of claim 13, wherein feedback regarding the position of the hydraulic actuator is provided to each of the first flight control computer and the second flight control computer.

15. The aircraft of claim 14, wherein a hardover extension failure is detected when at least one of (1) a commanded position of the actuator shaft does not match an actual position of the actuator shaft and (2) a hydraulic valve position feedback does not match a commanded position, and (3) a delta-pressure sensor indicates that pressure across at least one of the lower cylinder piston and the upper cylinder piston does not conform to a predetermined pressure or range of pressures.

16. The aircraft of claim 15, wherein in response to a hardover extension failure being detected, electrical control output to a healthy hydraulic control valve at least partially offsets the forces of the failed system and external actuator load forces.

17. A method of operating an aircraft, comprising:
providing an aircraft comprising a first flight control computer, a second flight control computer, and a hydraulic actuator, the hydraulic actuator comprising:
a lower cylinder comprising a lower cylinder extension area and a lower cylinder retraction area;
an upper cylinder comprising an upper cylinder extension area and an upper cylinder retraction area; and
an actuator shaft, comprising:
a lower cylinder piston disposed in the lower cylinder;
an upper cylinder piston disposed in the upper cylinder;
a lower shaft connecting the lower cylinder piston to the upper cylinder piston; and
an upper shaft extending from the upper cylinder piston and at least partially externally from the upper cylinder;
wherein fluid flow of the lower cylinder matches fluid flow of the upper cylinder and at least one of (1) an internal diameter of the lower cylinder is not equal to an internal diameter of the upper cylinder and (2) a diameter of the lower shaft is not equal to a diameter of the upper shaft.
providing a lower hydraulic control valve coupled to the first flight control computer and an upper hydraulic control valve coupled to the second flight control computer;
detecting a hardover extension failure in the hydraulic actuator in response to failure of one of the lower hydraulic control valve and the upper hydraulic control valve; and
providing an electrical control output to a healthy hydraulic control valve to retract the hydraulic actuator to mitigate the hardover extension failure.

18. The method of claim 17, wherein the first hydraulic control valve is configured to selectively move fluid in the lower cylinder, and wherein the second hydraulic control valve is configured to selectively move fluid in the upper cylinder.

19. The method of claim 17, wherein in response to failure of the lower hydraulic control valve, the second flight control computer commands the upper hydraulic control valve to retract the hydraulic actuator, and wherein in response to o failure of the upper hydraulic control valve, the first flight control computer commands the lower hydraulic control valve to retract the hydraulic actuator.

20. The method of claim 17, wherein the hydraulic actuator is configured to overcome the extension force applied in the hydraulic actuator by the failed hydraulic control valve.
